(19) United States
(12) Patent Application Publication
(10) Pub. No.: US 2004/0020682 A1
(43) Pub. Date: Feb. 5, 2004

(54) Pliable connector and manufacturing method thereof

(75) Inventors: Ming-Hsien Chou, Taipei Hsien (TW); Wen-Chun Chen, Taipei Hsien (TW)

Correspondence Address: BACON & THOMAS, PLLC, 625 SLATERS LANE, FOURTH FLOOR, ALEXANDRIA, VA, 22314

(73) Assignee: Akira Technology Co., Ltd., Taipei (TW)

(21) Appl. No.: 10/633,516

(22) Filed: Aug. 5, 2003

Related U.S. Application Data
(62) Division of application No. 10/123,174, filed on Apr. 17, 2002.

(51) Int. Cl. H01B 7/08

(52) U.S. Cl. 174/117 F

(57) ABSTRACT

The invention relates to a pliable connector comprising a plurality of metal conductor wires arranged as the plurality of parallel coplanar ones being equally spaced apart, a first insulated medium for embedding the conductor wires to form an insulated layer wherein the spacing between any two adjacent conductor wires is not changed and either end of the insulated layer is open, and a second insulating medium coated on both sides of the insulated layer to form a lamination with a predetermined thickness so as to possess a predetermined flexibility and strength and be cut into a plurality of said pliable connectors with predetermined size.

### FIELD OF THE INVENTION

The present invention relates to connector manufacturing and more particularly to pliable connector and manufacturing method thereof with improved characteristics.

### BACKGROUND OF THE INVENTION

It is typical for an electronic device provided with one or more connectors. For example, a cellular phone has a circuit board with various circuit components mounted thereon. The cellular phone further comprises a microphone in a position proximate user's mouth for ease of access in use. In a typical manufacturing process, pins of microphone are inserted into holes on the circuit board prior to securing by soldering. However, such securing is excessively rigid. In a case that a user carelessly drops the cellular phone or the cellular phone contacts other object, a strong vibration of internal components thus caused may break pins of the microphone. Hence, prior art securing of the microphone and the cellular phone is disadvantageous.

Various solutions with respect to above problem have been proposed. For example, as shown in FIG. 5, an arrangement is illustrated. A microphone housing 4 formed of insulating medium comprises an opening 401, a receiving space 41 open to opening 401 for receiving a microphone 5 therein, an engagement surface 42 opposed to opening 401, and a flexible zebra connector 43 on engagement surface 42, the zebra connector 43 having a plurality of parallel conductors 431 equally spaced apart by insulating media. One portion of conductors 431 is extended into receiving space 41 through engagement surface 42 so as to contact positive electrode 51 and negative electrode 52 of microphone 5, while the other portion thereof is projected from engagement surface 42. When engagement surface 42 is rested on circuit board 6, positive electrode 51 and negative electrode 52 of microphone 5 are thus in electrical connection with contacts 61 and 62 of circuit board 6 respectively.

The solution is advantageous in solving the problem of excessively rigid securing of the microphone and the cellular phone. But this is unsatisfactory for the purpose for which the invention is concerned for the following reasons: The manufacturing process of the flexible zebra connector 43 is tedious and time consuming involving the steps of employing complicated control devices, laminating, and cutting into a plurality of parallel conductors 431 equally spaced apart by insulating media. Further, a high volume percentage of conductor 431 is formed of carbon. This in turn increases a resistance value of the conductor 431. Hence, in mobile communication a cellular phone having such construction may suffer the drawbacks of interference, unreliable communication, and power consuming. This can adversely affect the applicability of such cellular phone.

Thus, it is desirable to provide an improved pliable connector and manufacturing method thereof in order to overcome the above drawbacks of prior art.

### SUMMARY OF THE INVENTION

It is therefore an object of the present invention to provide a pliable connector manufacturing method comprising the steps of arranging a plurality of metal conductor wires as the plurality of parallel coplanar ones being equally spaced apart by means for preparation; embedding the conductor wires in an insulating medium to form an insulated layer wherein the spacing between any two adjacent conductor wires is not changed and either end of the insulated layer is open; coating both sides of the insulated layer with the insulating medium to form a lamination with a predetermined thickness so as to possess a predetermined flexibility and strength; cutting the lamination into a plurality of first connectors with predetermined size by means of cutting; placing the first connector in a mold; and forming a second connector on the mold by molding so that the first and the second connectors are capable of coupling together to form an electrical connection between two elements of an electronic device.

It is another object of the present invention to provide a pliable connector comprising a plurality of metal conductor wires arranged as the plurality of parallel coplanar ones being equally spaced apart; a first insulated medium for embedding the conductor wires to form an insulated layer wherein the spacing between any two adjacent conductor wires is not changed and either end of the insulated layer is open; a second insulating medium coated on both sides of the insulated layer to form a lamination with a predetermined thickness so as to possess a predetermined flexibility and strength wherein means of cutting is employed to cut the lamination into a plurality of first connectors with predetermined size; and connector means formed around the pliable connector by molding so that the pliable connector and the connector means are capable of coupling together with both ends of the pliable connector contacted with two elements of an electronic device respectively so as to form an electrical connection therebetween. The invention has advantages of easy, fast assembly in the electronic device and a high shock absorption of the formed electronic device.

The above and other objects, features and advantages of the present invention will become apparent from the following detailed description taken with the accompanying drawings.

### BRIEF DESCRIPTION OF THE DRAWINGS

FIG. 1 is a flow chart illustrating a pliable connector manufacturing process according to the invention;

FIG. 2 is a perspective view with a portion cut off to show interior features of a first connector according to the invention;

FIG. 3 is a cross-sectional view of display, first connector, and circuit board mounted in a cellular phone;

FIG. 4 is an exploded view showing the first connector incorporated in a cellular phone according to the invention; and

FIG. 5 is an exploded view showing a conventional connector incorporated in a cellular phone.

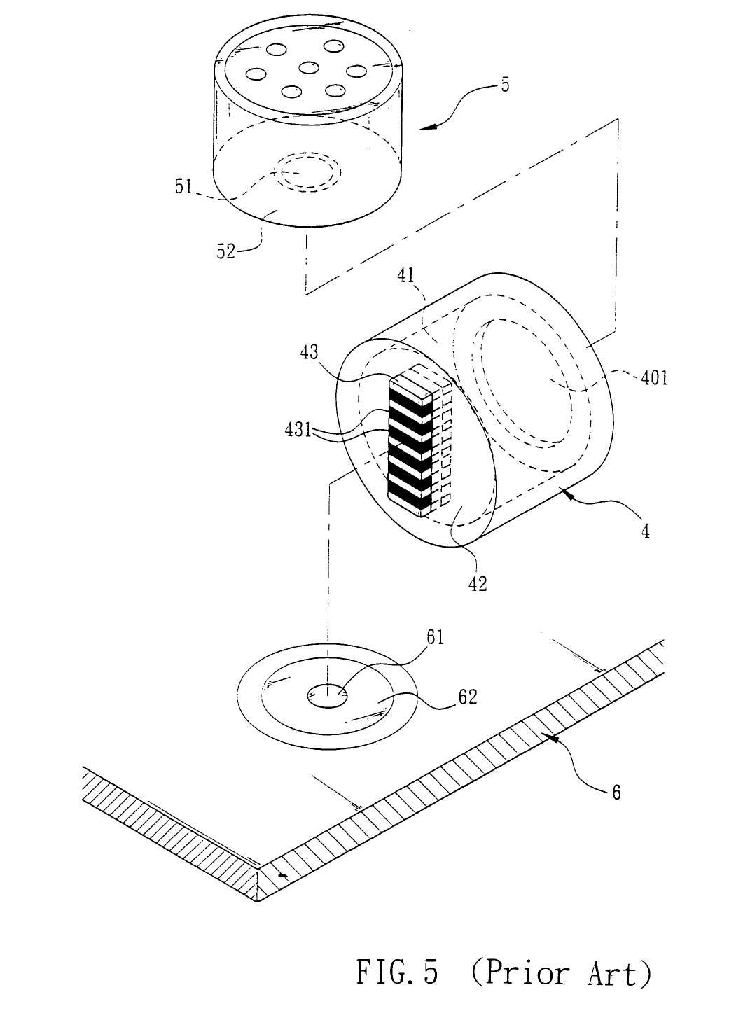

### DETAILED DESCRIPTION OF THE PREFERRED EMBODIMENTS

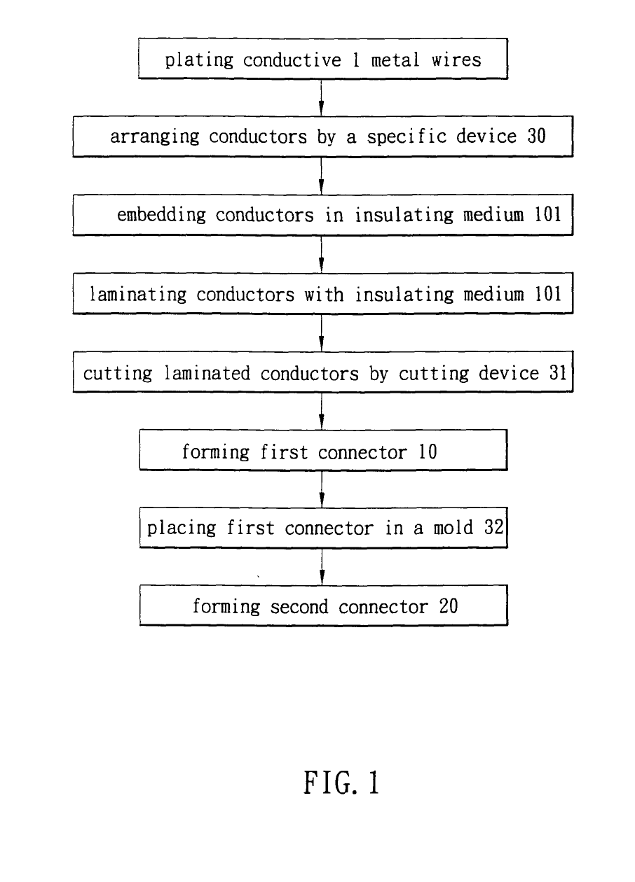

Referring to FIG. 1, there is shown a flow chart illustrating a process for manufacturing pliable connector in accordance with the invention. The process comprises the steps of plating a plurality of conductive metal wires with gold to form gold plated conductors 1; arranging the plurality of gold plated conductors 1 as a plurality of parallel coplanar ones being equally spaced apart (i.e., similar to warp in weaving) by a specific device 30 wherein conductor 1 has a diameter about ø0.03 mm to about 0.05 mm and any two adjacent conductors 1 have a spacing about 0.05 mm to about 0.1 mm; embedding conductors 1 in an insulating medium 101 (e.g., silicone rubber in the embodiment) to form an insulated layer wherein above spacing between any two adjacent conductors 1 is still maintained; coating both sides of the insulated layer with insulating medium 101 until a predetermined thickness is obtained (i.e., laminated) so as to be pliable while without losing strength; cutting the laminated conductors 1 into a plurality of first connectors 10 with predetermined size by a cutting device 31; placing the connector 10 in a mold 32; and forming a second connector 20 on the mold 32 by injection molding or drawing technique. The injection molding or drawing technique is well known. Thus a detailed description thereof is omitted herein for the sake of brevity.

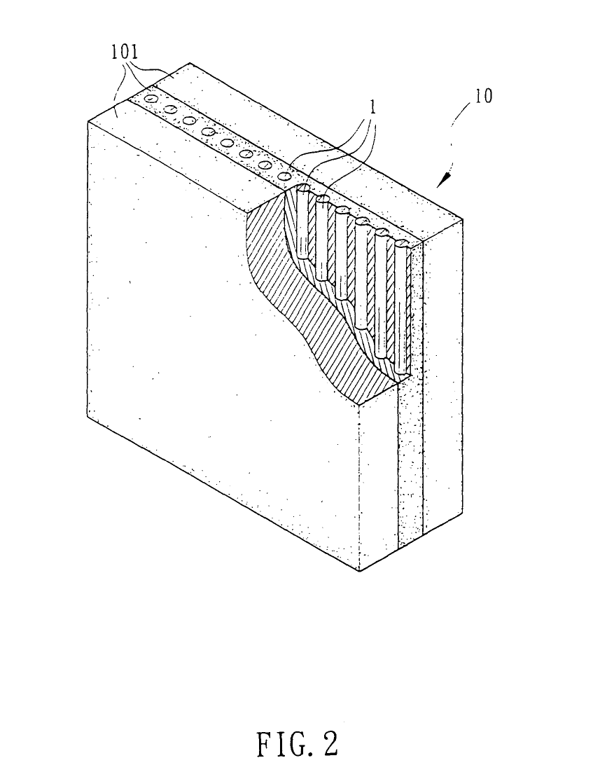

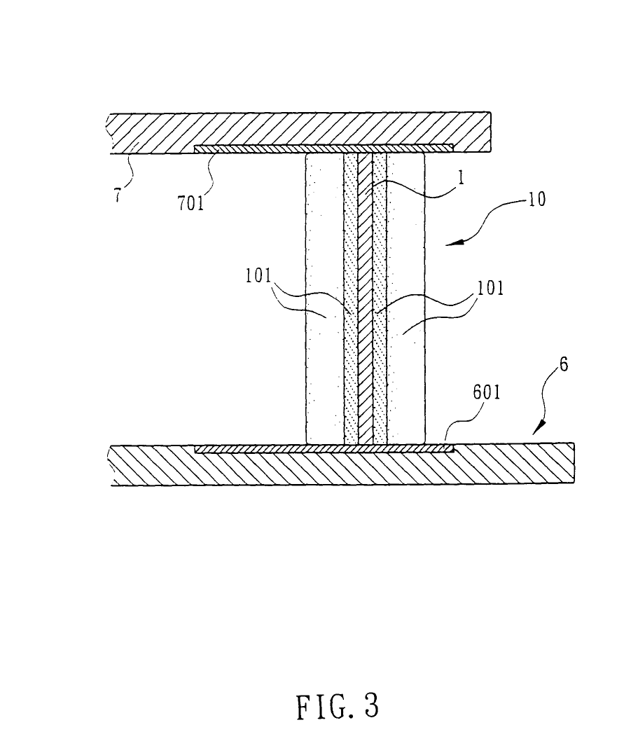

Referring to FIGS. 2 and 3, the first connector 10 is a pliable member having a plurality of parallel conductors 1 equally spaced apart. Also, top and bottom ends of conductors 1 are open. In an implementation, top ends of conductors 1 are coupled to contact 701 of a display 7 while the bottom ends thereof are coupled to contact 601 of circuit board 6 so as to form an electrical connection between display 7 and circuit board 6. It is contemplated that advantages of easy, fast assembly of the connector of the invention in an electronic device and a high shock absorption of the electronic device are obtained.

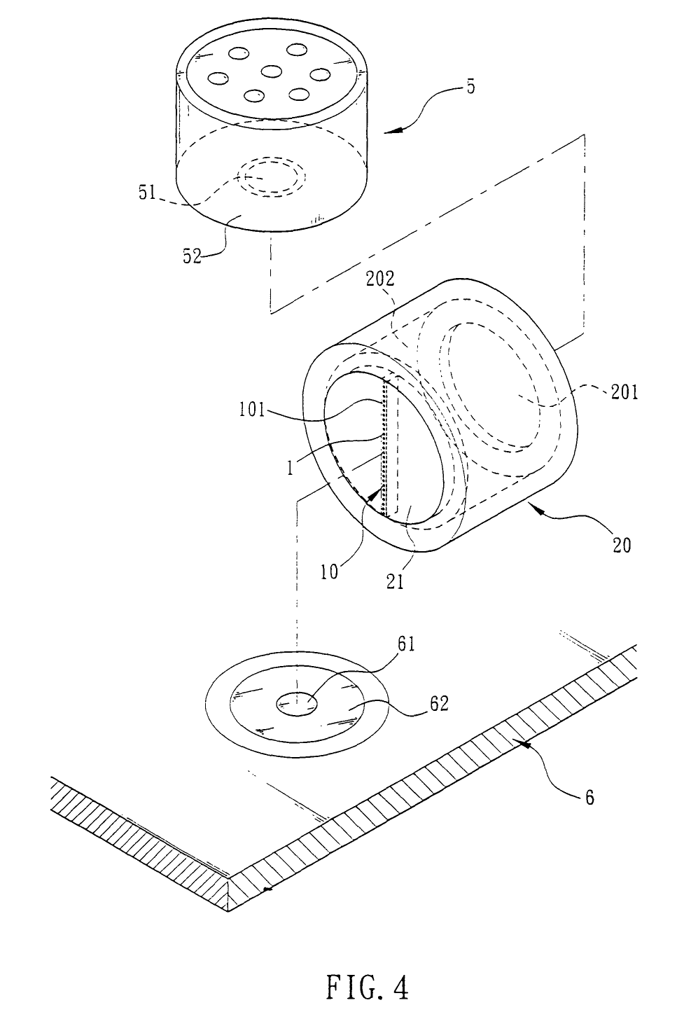

Referring to FIG. 4, the application of first and second connectors 10 and 20 in a cellular phone is illustrated. As shown, second connector 20 is implemented as a microphone housing being shaped as a cylinder. The second connector 20 comprises an opening 201, a receiving space 202 open to opening 201 for receiving a microphone 5 therein, and an engagement surface 21 opposed to opening 201 while facing contacts 61 and 62 of circuit board 6. The pliable first connector 10 is positioned on engagement surface 21 being extended radially. The parallel conductors 1 of first connector 10 are extended axially, i.e., one portion of conductors 1 is extended into receiving space 202 through engagement surface 21 so as to contact positive electrode 51 and negative electrode 52 of microphone 5, while the other portion thereof is projected from engagement surface 21. When engagement surface 21 is rested on circuit board 6, positive electrode 51 and negative electrode 52 of microphone 5 are thus in an electrical connection with contacts 61 and 62 of circuit board 6 respectively.

The invention further comprises other advantages. For example, in a case that a user carelessly drops a cellular phone or the cellular phone contacts other object, a strong vibration of internal components thus caused may not break pins of the microphone. Hence, the securing of the microphone and the cellular phone is reliable.

While the invention has been described by means of specific embodiments, numerous modifications and variations could be made thereto by those skilled in the art without departing from the scope and spirit of the invention set forth in the claims.

What is claimed is:

1. A pliable connector comprising:
a plurality of metal conductor wires arranged as the plurality of parallel coplanar ones being equally spaced apart;
a first insulated medium for embedding the conductor wires to form an insulated layer wherein the spacing between any two adjacent conductor wires is not changed and either end of the insulated layer is open; and
a second insulated medium coated on both sides of the insulated layer to form a lamination with a predetermined thickness so as to possess a predetermined flexibility and strength;
wherein means of cutting is employed to cut the lamination into a plurality of first connectors with predetermined size.

2. The pliable connector of claim 1, further comprising connector means formed around the pliable connector by molding so that the pliable connector and the connector means are capable of coupling together with both ends of the pliable connector contacted with two elements of an electronic device respectively so as to form an electrical connection therebetween.

3. The pliable connector of claim 2, wherein the connector means is a cylindrical microphone housing and comprises an opening, a receiving space open to the opening for receiving a microphone therein, and an engagement surface opposed to the opening so that the pliable connector is positioned on the engagement surface being extended radially, one portion of the parallel conductor wires of the pliable connector is extended axially into the receiving space through the engagement surface for contacting a positive electrode and a negative electrode of the microphone, the other portion thereof is projected from the engagement surface, the engagement surface is rested on a circuit board, and the positive and the negative electrodes of the microphone are in an electrical connection with contacts of the circuit board respectively.

4. The pliable connector of claim 1, wherein each of the first and the second insulating media is formed of a first plastic material.

5. The pliable connector of claim 1, wherein the first and the second insulating media are formed of a first plastic material and a second plastic material being different from the first plastic material respectively.
